(19) United States
(12) Patent Application Publication
(10) Pub. No.: US 2007/0120027 A1
(43) Pub. Date: May 31, 2007

(54) Suction cup

(76) Inventor: Ta Shuo Chang, Taipei (TW)

Correspondence Address: BRUCE H. TROXELL;SUITE 1404, 5205 LEESBURG PIKE, FALLS CHURCH, VA, 22041, US

(21) Appl. No.: 11/346,334

(22) Filed: Feb. 3, 2006

(30) Foreign Application Priority Data
Nov. 28, 2005 (TW) 094220629
Dec. 13, 2005 (CN) 200520144244.3

(51) Int. Cl. F16B 47/00

(52) U.S. Cl. 248/205.5

(57) ABSTRACT

A suction cup includes a resilient plate including a concave bottom and a threaded middle projecting post; a bell including a support pivotably secured in an upper receptacle, an annular flange on a lower end, an internal space open to both lateral sides, a nut in the space threadedly engaged with the middle projecting post; and a pressing member disposed inside bell bottom being in contact with the flange, the pressing member including bottom pressing elements. Placing the suction cup onto a surface and continuously turning the nut will draw both the plate and the bell toward the surface and draw the pressing member onto the plate until a vacuum in a cavity between the plate and the surface is created to adhere the plate to the surface. The pressing elements are ribs or teeth having arcuate or straight shape.

### BACKGROUND OF THE INVENTION

1. Field of Invention

The present invention relates generally to suction devices and more particularly to a suction cup with improved characteristics (e.g., increased sucking force).

2. Description of Related Art

There have been numerous suggestions in prior patents for suction cups. For example, one of the typical suction cup discloses a suction cup characterized in that a seat is put on the bell, a rubber ring is provided on the seat, a plurality of ribs are extended outward from the ring, and a pressing member is provided under the ribs such that pressing the bell will cause the pressing member to press the suction cup for securely adhering to the surface. Another typical suction cup discloses a suction cup characterized in that a fastening member is provided around the bell, and a threaded member is adapted to drive the bell upward a surface to create a vacuum therebetween so as to adhere to the surface with the additional help of lockingly engaging annular studs of the fastening member with grooves of a plate. The other typical one of suction cup discloses a suction cup characterized in that pressing a plate onto a surface and rotatably drive a cover to press same onto a periphery of the plate so as to create a vacuum that forces the plate to adhere to the surface.

Such prior sucking mechanisms are typically able to create a small sucking force. Hence, only a lightweight object can be supported by the suction cup. Further, their are relatively complex in constructions, trouble-prone, and unreliable in use. Thus, the need for improvement still exists.

### SUMMARY OF THE INVENTION

It is therefore an object of the present invention to provide a suction cup comprising a resilient plate including a concave bottom and a projecting post having outer threads; a bell including a receptacle on an upper end thereof, a support pivotably secured in the receptacle, a bell body on a lower end thereof, an internal space open to both lateral sides of the bell body, a nut provided in the space, and an internal opening in communication with the space wherein the projecting post passes the opening to threadedly engage with the nut; and a pressing member put on a central portion of the plate around the middle part, the pressing member being disposed inside a bottom of the bell and being in contact with an inner bottom surface of the bell body, the pressing member including an annular member 31 and a plurality of pressing elements formed on a bottom of the annular member 31 whereby placing the suction cup onto a surface and continuously turning the nut will draw both the plate and the bell toward the surface and draw the pressing member onto the plate until a cavity defined by the plate and the surface is decreased to about zero for creating a vacuum to adhere the plate to the surface. By utilizing this suction cup, an increased sucking force is created.

In an aspect of the present invention the pressing elements are shaped as either ribs or teeth.

In another aspect of the present invention the pressing elements are either arcuate or straight.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of suction cup according to the invention;

FIG. 2 is an exploded view of the suction cup;

FIG. 3 is a cross-sectional view of the suction cup in its inoperative state;

FIG. 4 is a cross-sectional view of the suction cup in its operating state;

FIG. 5 is a detailed view of the area in circle of FIG. 3;

FIG. 6 is a detailed view of the area in circle of FIG. 4;

FIG. 7 is a bottom view of the suction cup with the plate removed;

FIG. 8 is a bottom view of the suction cup of another embodiment of the present invention with the plate removed; and

FIG. 9 is an environmental view of the suction cup with a device cradle mounted onto a support thereof.

### DETAILED DESCRIPTION OF THE INVENTION

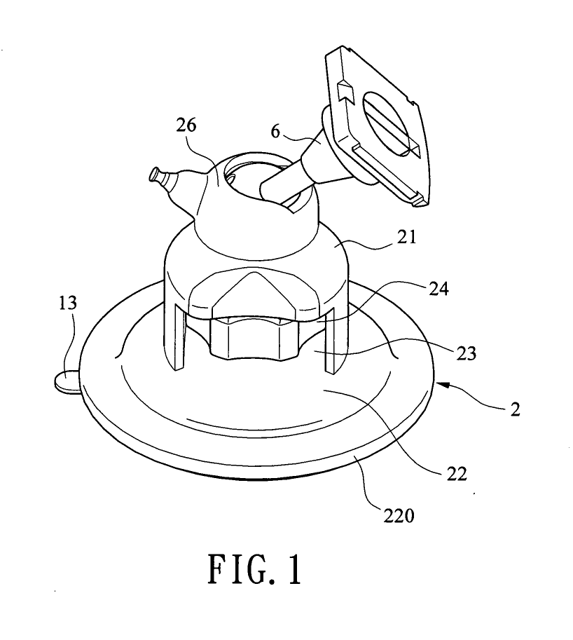

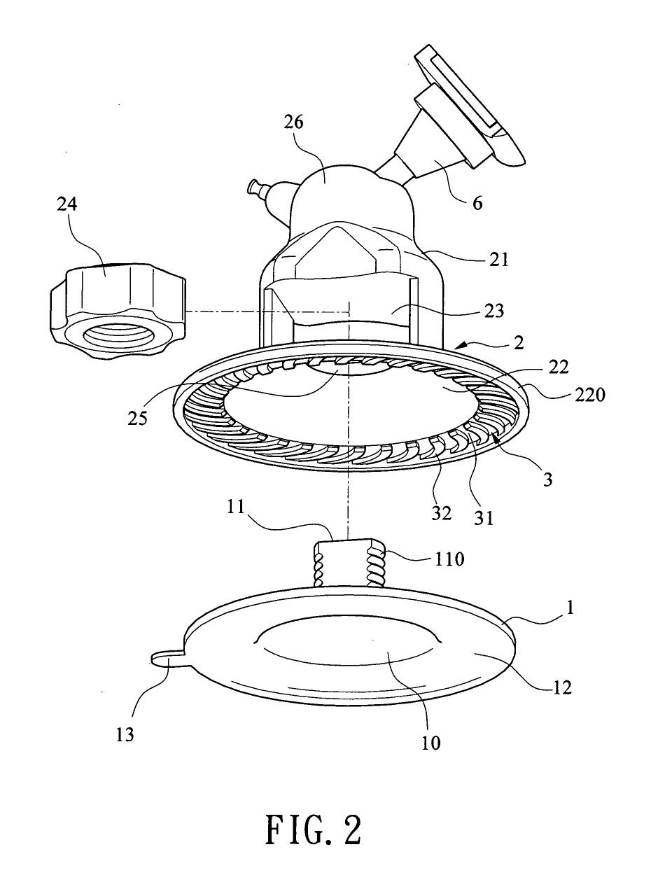

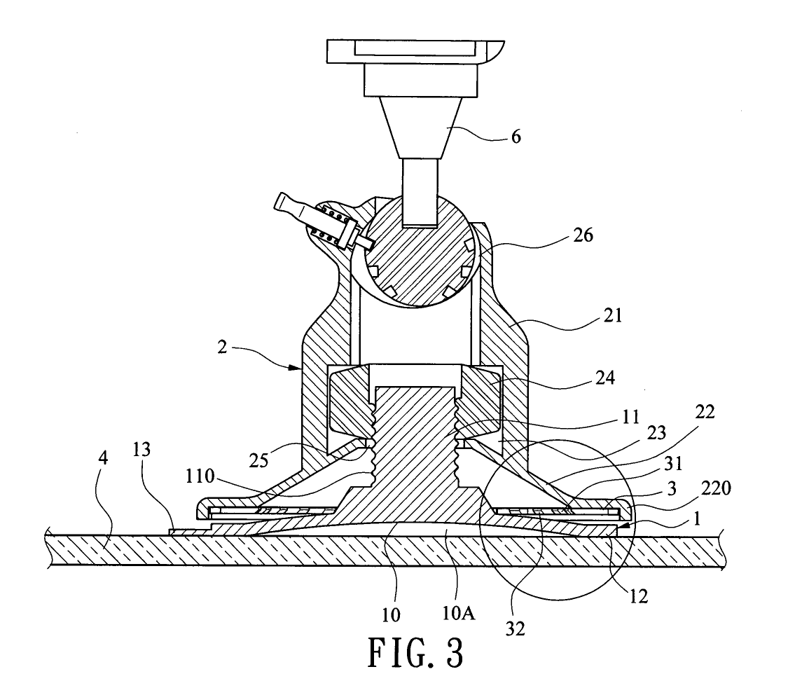

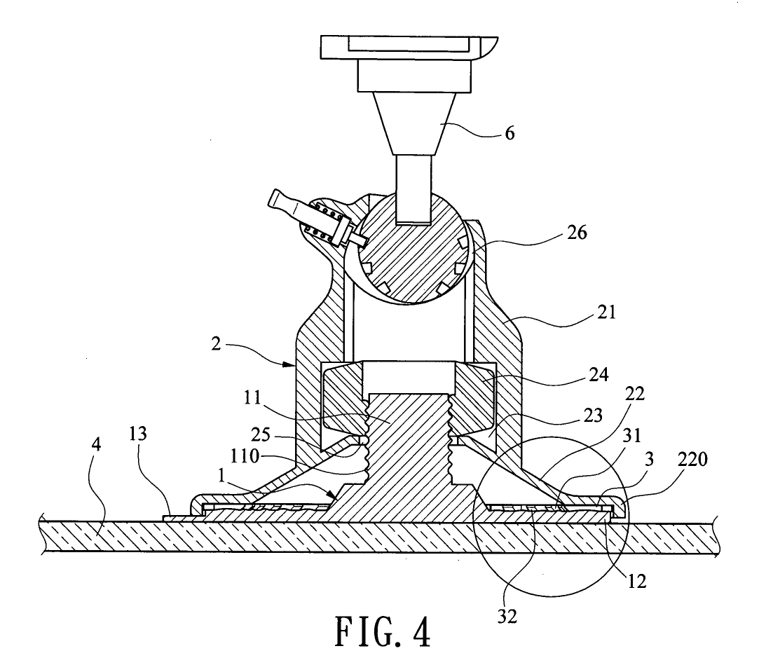

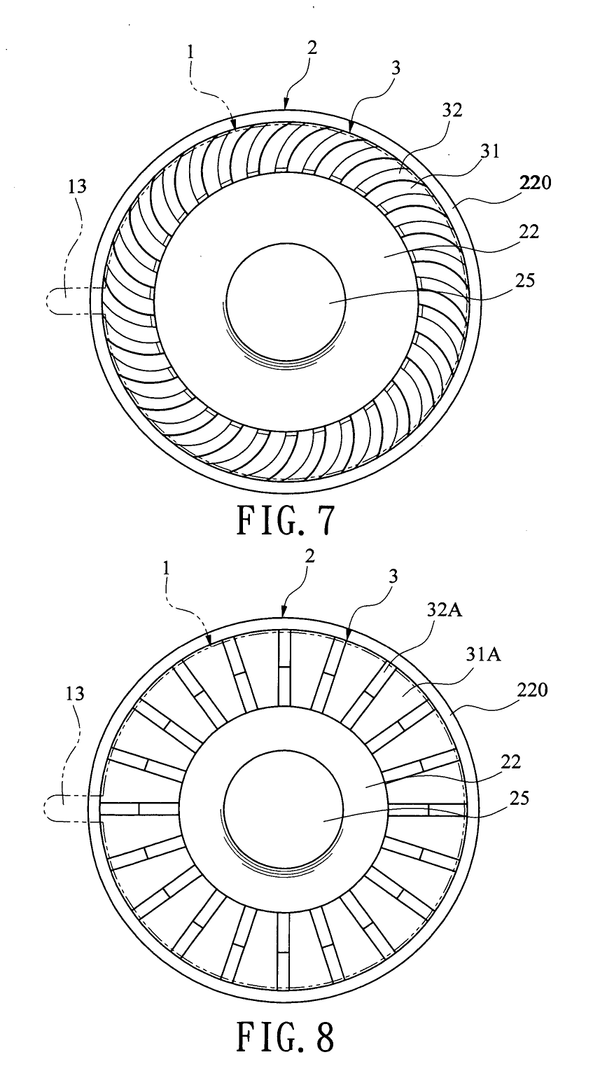

Referring to FIGS. 1 and 2, a suction cup in accordance with a preferred embodiment of the invention comprises a resilient circular plate 1 formed of soft plastics or rubber, having a slight concave configuration and including a middle projecting post 11 having outer threads 110, a central concave portion 10 on a bottom of the projecting post 11, an annular flat portion 12 on an outer circumferential portion of the concave portion 10, and a tab on an outer portion of the annual flat portion 12; a bell 2 including a main body 21, a spherical receptacle 26 on an upper end of the body 21, a bell member 22 on a lower portion of the body 21, an annular downward flange 220 on a circumference of the bell member 22, an internal space 23 open to both lateral sides of the body 21, a nut 24 provided in the space 23, and an opening 25 disposed on the top of the bell member 22 in communication with the space 23 wherein the projecting post 11 passes the opening 25 to threadedly engage with the nut 24; and an annular pressing member 3 put on the annular flat portion 12 of the resilient circular plate 1 and being disposed inside a concave bottom of the bell body 21 or an inner bottom surface of the bell member 22 and being in contact with an inner surface of the bell member 22, the pressing member 3 including an annular member 31 and a plurality of pressing elements in the form of arcuate ribs, or arcuate teeth 32, or the like formed on a bottom of the annular member 31, as shown in FIG. 7. Note that the pressing elements in another embodiment of the present invention may be shaped in the form of straight ribs, teeth 32A, or the like formed on a bottom of the annular member 31A, as shown in FIG. 8. In order to facilitate the suction cup to have immovably retained on the surface 4, the diameter of the plate (1) is intentionally designed to be smaller than that of the bell member 22 of the bell (2), and the bottom of the flange 220 is higher than that of the plate (1), as shown in FIGS. 3 and 4.

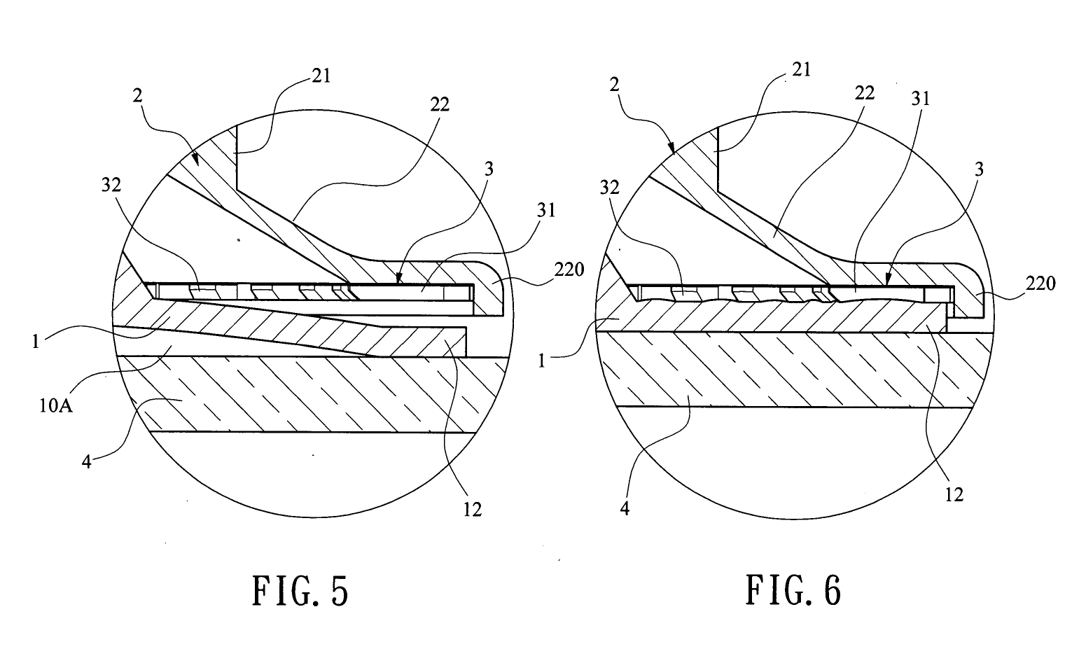

Referring to FIGS. 3 to 8, a sucking operation of the invention will be described in detailed below. Place the suction cup onto a flat surface 4, as shown in FIG. 3. Next, continuously turn the nut 24 with one hand to draw both the projecting post 11 and a bell member 22 (i.e., the bell 2) toward the surface 4 and draw the pressing member 3 toward the annular flat portion 12 of the resilient circular plate 1 until a cavity 10A defined by the concave portion 10 of the plate 1 and the surface 4 is decreased to about zero (as shown in FIG. 4) in order to create a vacuum for causing the resilient circular plate 1 (i.e., the suction cup) to adhere to the surface 4. Note that the sucking force is greatly enhanced since the pressing elements 32·32A having been greatly increased its actuated area are urged against a whole top of the plate 1 by excessively tightening the nut 24. As a result, the suction cup is immovably and captively retained on the surface 4 by the created vacuum as shown particularly in FIGS. 4-8. The above immovably retained state of suction cup on the surface 4 will be changed if the tab 13 is pulled up by hand.

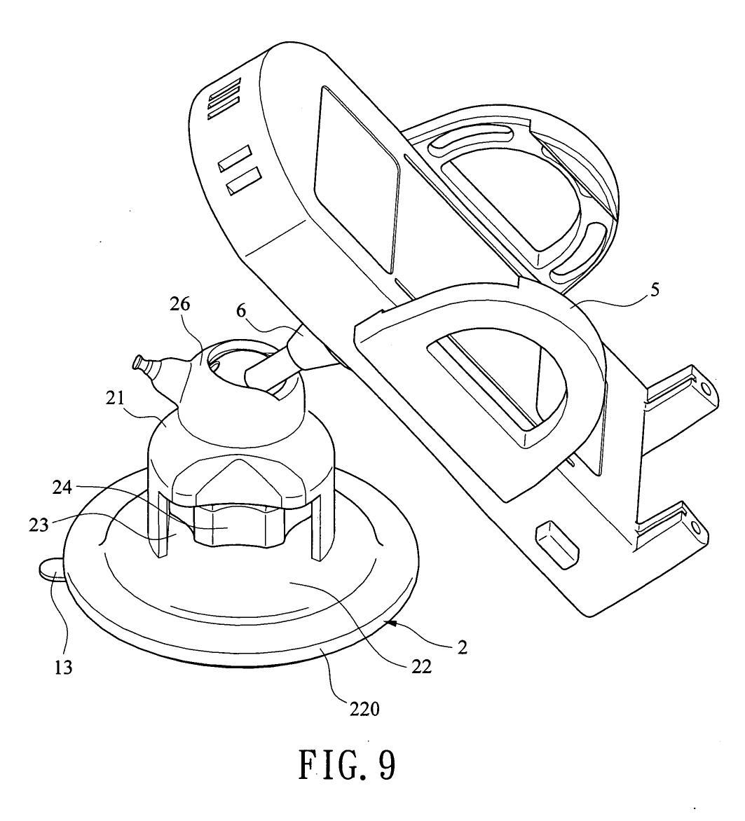

Referring to FIG. 9, an application of the invention will be described in detailed below. The suction cup is mounted on a place (e.g., instrument board of an automobile). A device (e.g., mobile phone, PDA (Personal Digital Assistant), or the like) may be secured to a cradle 5 which is in turn mounted on a support 6 having a leg pivotably provided in the receptacle 26.

While the invention herein disclosed has been described by means of specific embodiments, numerous modifications and variations could be made thereto by those skilled in the art without departing from the scope and spirit of the invention set forth in the claims.

What is claimed is:

1. A suction cup comprising:
a resilient circular plate (1) including a middle projecting post (11) having an outer threads (110) thereon, a central concave portion (10 ) on a bottom of the projecting post 11, an annular flat portion (12) on an outer circumferential portion of the concave portion (10);
a bell (2) including a main body (21), a spherical receptacle (26) on an upper end of the body (21), a bell member (22) on a lower portion of the body (21), an annular downward flange (220) on a circumference of the bell member (22), an internal space (23) open to both lateral sides of the body (21), a nut (24) provided in the space (23), and an internal opening (25) on the top of the bell member (22) in communication with the space (23) wherein the projecting post (11) passes the opening ( 25) to threadedly engage with the nut (24); and
an annular pressing member (3) put on the annular flat portion (12) of the resilient circular plate (1), the pressing member (3) being disposed inside a concave bottom of the bell body (21) and being in contact with the bell member (22), the pressing member (3) including an annular member (31) and a plurality of pressing elements (32) on the bottom of annular member (31),
whereby placing the suction cup onto a surface (4) and continuously turning the nut (24) will draw both the plate (1) and the bell body (21) toward the surface (4) and draw the pressing member (3) onto the plate (1) until a cavity (10A) defined by a bottom of the plate (1) and the surface (4) is decreased to about zero for creating a vacuum to adhere the plate (1) to the surface (4).

2. The suction cup of claim 1, wherein the pressing elements (3) are shaped as ribs.

3. The suction cup of claim 1, wherein the pressing elements (3) are shaped as teeth.

4. The suction cup of claim 1, wherein the pressing elements (3) are arcuate ribs.

5. The suction cup of claim 1, wherein the pressing elements (3) are straight ribs.

6. The suction cup of claim 1, wherein the plate (1) is formed of soft plastics or rubber.

7. The suction cup of claim 1, wherein a tab (13) is further provided on an outer portion of the annual flat portion (12).

8. The suction cup of claim 1, wherein a support (6) is further pivotably secured in the spherical receptacle (26).

9. The suction cup of claim 1, wherein a diameter of the plate (1) is smaller than that of the bell member (22) of the bell (2).
